(19) United States
(12) Patent Application Publication
(10) Pub. No.: US 2023/0055061 A1
(43) Pub. Date: Feb. 23, 2023

(54) IMAGE FORMING APPARATUS

(71) Applicant: KYOCERA Document Solutions Inc., Osaka (JP)

(72) Inventor: Katsuo Mikashima, Osaka (JP)

(21) Appl. No.: 17/885,861

(22) Filed: Aug. 11, 2022

(30) Foreign Application Priority Data
Aug. 19, 2021 (JP) 2021-134385

(51) Int. Cl. H04N 1/393; H04N 1/00

(52) U.S. Cl. CPC H04N 1/3935; H04N 1/0071

(57) ABSTRACT

A print engine physically prints an image to be printed on a print sheet in an inkjet manner. A correction processing unit performs a correction process for a specific image column range corresponding to a configuration or a status of the print engine. Further, when performing duplex printing on first and second surfaces of the print sheet, the correction processing unit performs an image shrinking process for an image to be printed on the second surface in accordance with shrinking the print sheet due to ink ejection to the first surface, and Furthermore, the correction processing unit selects an image column range other than the specific image column range in the image to be printed on the second surface as a target image column range for which the image shrinking process should be performed.

### CROSS-REFERENCE TO RELATED APPLICATIONS

This application relates to and claims priority rights from Japanese Patent Application No. 2021-134385, filed on Aug. 19, 2021, the entire disclosures of which are hereby incorporated by reference herein.

### BACKGROUND

### 1. Field of the Present Disclosure

The present disclosure relates to an image forming apparatus.

### 2. Description of the Related Art

When performing duplex printing, in order to improve an image quality of a second surface of the recording medium after slightly zooming an image for the second face in accordance with shrinking of the recording medium due to ink ejection to a first surface, an image forming apparatus sets a processing window of a pixel width preset in a primary scanning direction with a period based on a zooming ratio of the zooming, and sets a density required of a pixel to be deleted on the basis of an average density of the processing window.

Further, if a large gradation level change appears in a periphery of a target pixel to be deleted, another image forming apparatus does not perform deleting the target pixel.

However, in the aforementioned image forming apparatus, sorts of correction processes are performed, and the aforementioned deleting pixel affects another correction process and consequently may result in a low image quality.

### SUMMARY

An image forming apparatus according to an aspect of the present disclosure includes a print engine, and a correction processing unit. The print engine is configured to physically print an image to be printed on a print sheet in an inkjet manner. The correction processing unit is configured to perform a correction process for a specific image column range corresponding to a configuration or a status of the print engine. Further, when performing duplex printing on first and second surfaces of the print sheet, the correction processing unit performs an image shrinking process for an image to be printed on the second surface in accordance with shrinking the print sheet due to ink ejection to the first surface. Furthermore, the correction processing unit selects an image column range other than the specific image column range in the image to be printed on the second surface as a target image column range for which the image shrinking process should be performed.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a block diagram that indicates an electronic configuration of the image forming apparatus 10 in the embodiment according to the present disclosure;

FIG. 3 shows a diagram that explains divisional images of an image to be printed on the second surface;

FIG. 4 shows a diagram that indicates an example of a pixel deleting process;

FIG. 5 shows a diagram that indicates another example of a pixel deleting process; and

FIG. 6 shows a diagram that indicates further another example of a pixel deleting process.

### DETAILED DESCRIPTION

Hereinafter, an embodiment according to an aspect of the present disclosure will be explained with reference to drawings.

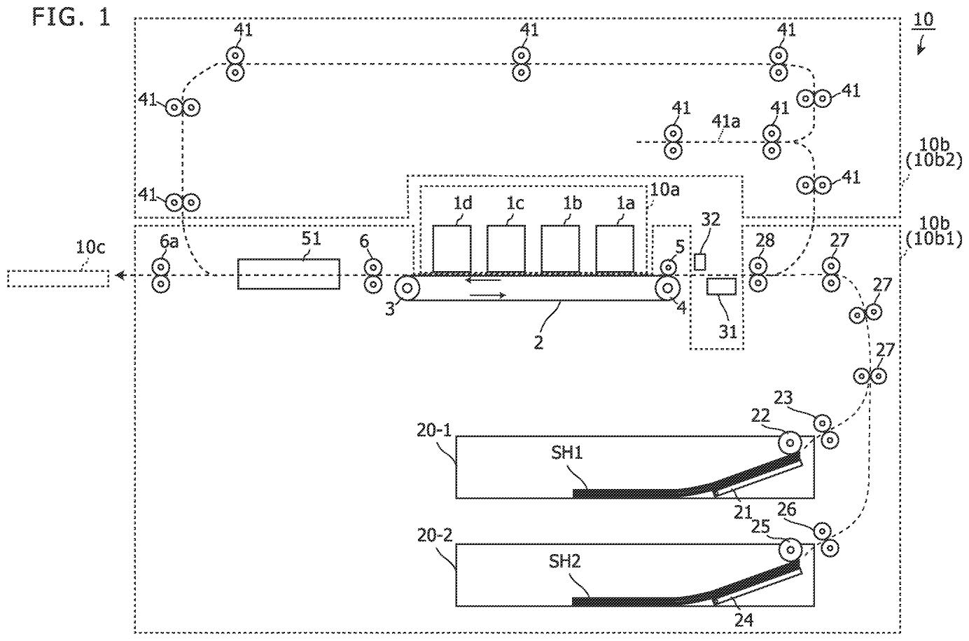

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 includes a print engine 10a and a sheet transportation unit 10b. The print engine 10a physically prints an image to be printed on a print sheet (print paper sheet or the like) in an inkjet manner. In this embodiment, the print engine 10a is a line-type inkjet print engine. In this embodiment, the print engine 10a includes line-type inkjet recording units 1a to 1d corresponding to four ink colors: Cyan, Magenta, Yellow, and Black. In this embodiment, each of the inkjet recording units 1a to 1d includes plural recording heads arrayed along a primary scanning direction.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a. Thus, the circulation sheet transportation unit 10b2 is used for duplex printing. For example, as shown in FIG. 1, a dryer 51 is installed in the sheet transportation unit 10b (in the main sheet transportation unit 10b1 or the circulation sheet transportation unit 10b2), and the dryer 51 blows warm air to the print sheet after printing and thereby dries the print sheet after printing. In duplex printing, the dryer 51 dries the print sheet after printing of the first surface before printing of the second surface. In this process, ink is dried on the first surface and consequently, the print sheet is shrunk.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a top end of the print sheet SH1 or SH2 passes through a predetermined position on the transportation path.

The line sensor 31 detects positions of both end edges of the print sheet SH1 or SH2 at a time point that the top end of the print sheet SH1 or SH2 is detected by the sheet detecting sensor 32. In duplex printing, the line sensor 31 detects a width of the print sheet in the primary scanning direction before and after printing of the first surface.

As shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

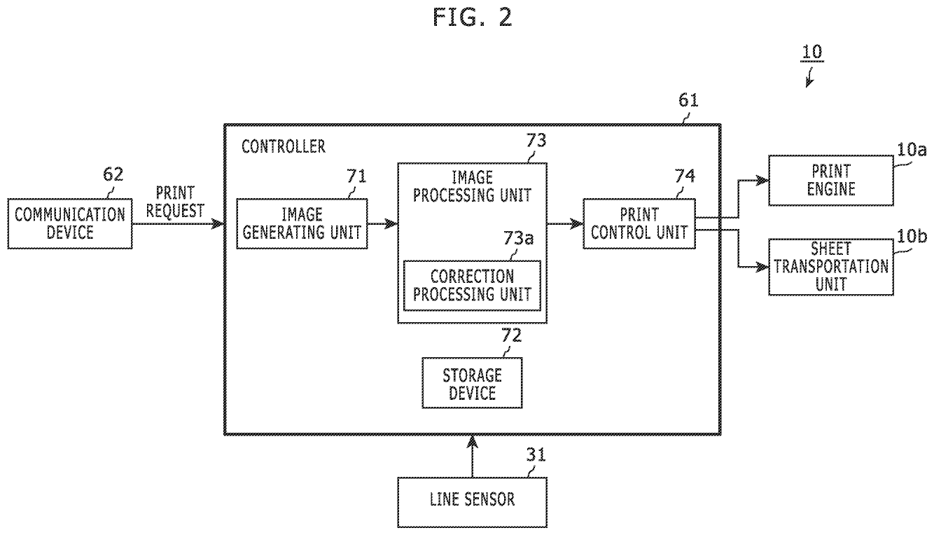

FIG. 2 shows a block diagram that indicates an electronic configuration of the image forming apparatus 10 in the embodiment according to the present disclosure. As shown in FIG. 2, the image forming apparatus 10 further includes a controller 61 and a communication device 62.

The control unit 61 performs image processing, controlling the print engine 10a and the sheet transportation unit 10b, and the like. The communication device 62 is a network interface for example, and receives a print request (e.g. a request including print data described in a page description language) from a host device.

The controller 61 includes an image generating unit 71, a storage device 72, an image processing unit 73, and a print control unit 74.

Specifically, the controller 61 includes a computer that executes a predetermined program, an ASIC (Application Specific Integrated Circuit) that performs a specific data process, and/or the like as a processing unit, and this processing unit acts as the image generating unit 71, the image processing unit 73, and the print control unit 74. The storage device 72 is a nonvolatile storage device such as flash memory, and stores data and/or a program used by the processing unit.

The image generating unit 71 generates from the print data in the print request raster image data of an image to be printed. The image processing unit 73 performs a predetermined image process for the aforementioned image data. Specifically, the image processing unit 73 performs image rotation, image combination, color conversion, color correction, halftoning and/or the like, as the predetermined image process. The print control unit 74 controls the print engine 10a in accordance with the image data after the image process and thereby performs printing, and controls the sheet transportation unit 10b and thereby performs transportation of a print sheet used for the printing.

In particular, the image processing unit 73 includes a correction processing unit 73a that performs a correction process for a specific image column range corresponding to a configuration of the print engine 10a (for example, a nozzle array in a boundary part of the recording head) or a status of the print engine 10a (for example, non-ejection nozzle due to ejection failure).

Further, when performing duplex printing on first and second surfaces of the print sheet, the correction processing unit 73a performs an image shrinking process for an image to be printed on the second surface in accordance with shrinking the print sheet due to ink ejection to the first surface. In addition, the correction processing unit 73a selects an image column range other than the specific image column range in the image to be printed on the second surface as a target image column range for which the image shrinking process should be performed.

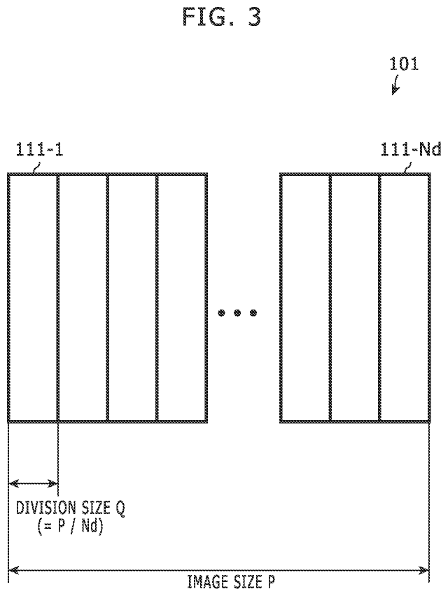

FIG. 3 shows a diagram that explains divisional images of an image to be printed on the second surface. Specifically, the correction processing unit 73a (a) derives the number of one or more pixels to be deleted M (i.e. the number of pixel columns to be deleted in the image shrinking process) on the basis of a width W2 of the print sheet in the primary scanning direction after printing of the first surface, (b) divides the print image 101 to be printed on the second surface into divisional images 111-1 to 111-Nd (Nd>1) in the primary scanning direction with a division size Q based on the number of one or more pixels to be deleted M and the number of parts of the aforementioned correction process H, and (c) selects the target image column range in a divisional image that does not include the specific image column range of the correction process among the divisional images 111-1 to 111-Nd.

Here, the number of one or more pixels to be deleted M, the shrinking ratio S, and the division size Q are derived in accordance with the following formulas.

M=W1−W2

S=(P−M)/P

Q=INT(P/(H+M))

Here, W1 is a width of the print sheet in the primary scanning direction before printing of the first surface, INT( ) is a function that rounds off a part under a decimal point and thereby performs integerizing, and P is a width (number of pixels) of an image to be printed. It should be noted that if plural correction processes are performed, H is set as a sum of the numbers of parts as targets of the plural correction processes.

For example, the correction process includes at least one of a step correction and a non-ejection nozzle correction. Here, the correction process is the step correction and the non-ejection nozzle correction, and H is set as a sum of the number of parts of the step correction H1 and the number of parts of the non-ejection nozzle correction H2 (H=H1+H2).

The step correction is correction performed for an image column range corresponding to a predetermined range at an end part of the recording head of the print engine 10a, in accordance with a nozzle interval between the recording heads, and the non-ejection nozzle correction is correction performed for an image column range corresponding to a nozzle not used for ink ejection among nozzles of the recording head of the print engine 10a.

Here, the number of parts of the step correction H1 is (the number of the recording heads arrayed in the primary scanning direction) −1. The step correction is performed for each boundary between two adjacent recording heads. The recording heads are arranged such that a part of the recording heads is shifted in a secondary scanning direction and boundary parts of the recording heads are overlapped in the primary scanning direction with a predetermined width, and here the step correction is performed for one image column in this predetermined width. Further, here, the number of parts of the non-ejection nozzle correction H2 is the number of non-ejection nozzles. The non-ejection nozzle correction is performed for ranges such as one or two pixels at both sides of an image column corresponding to the non-ejection nozzle.

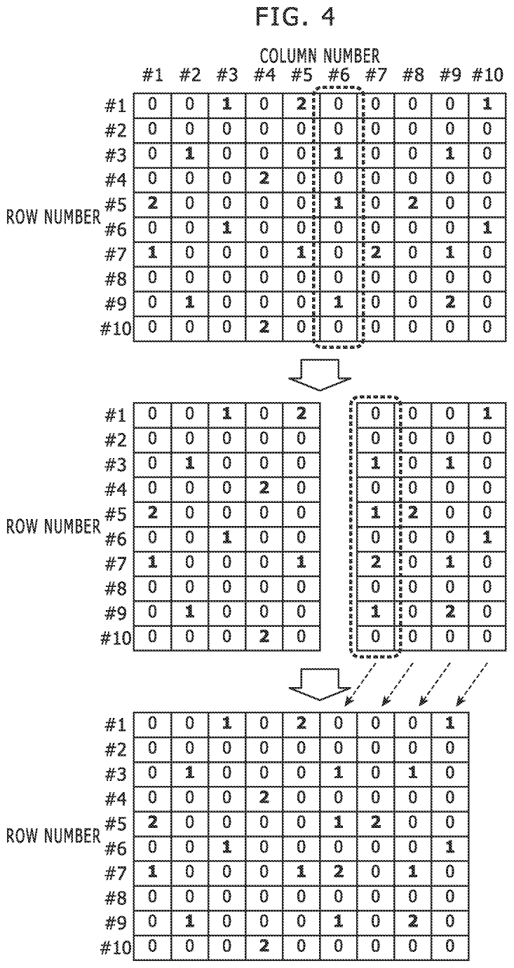

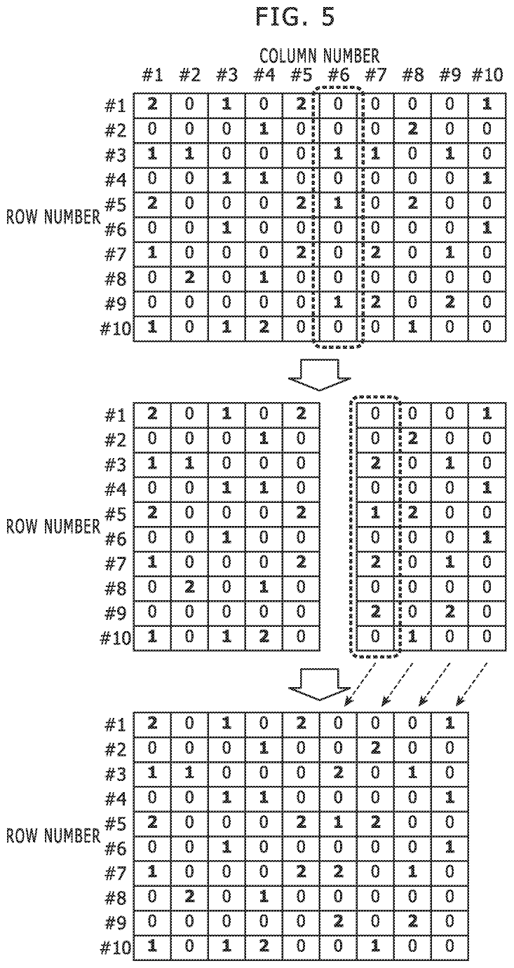

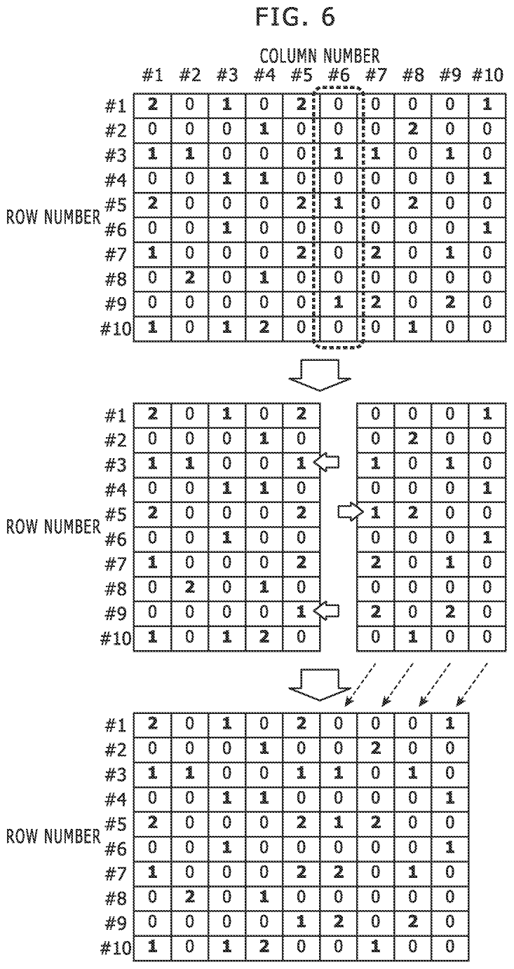

FIG. 4 shows a diagram that indicates an example of a pixel deleting process. FIG. 5 shows a diagram that indicates another example of a pixel deleting process. FIG. 6 shows a diagram that indicates further another example of a pixel deleting process. The pixel deleting process shown in FIGS. 4 to 6, one image column is deleted in an image area of 10 by 10 pixels (divisional image). Here, the center image column of column number 190 6 in the image area is selected as an image column to be deleted, in order not to be arranged adjacently to an image column to be deleted in an adjacent image area.

For example, as shown in FIG. 4, if the image column (pixel column) of column number #6 is selected as a target of the pixel deleting process, a pixel value (gradation value) of each row in column number #6 is added to a pixel value of this row in an adjacent image column of column number #7. Here, for example, as shown in FIG. 5, if the pixel value after the addition exceeds a maximum value (here, 2) such as the pixel value of a pixel in row number #9, the pixel value after the addition is clamped to this maximum value. Subsequently, image columns of column numbers #7 to #10 are changed to image columns of column numbers #6 to #9, and thereby the pixel deleting process is finished. Here, the gradation value is any of 0, 1, and 2, and corresponds to an ink ejection amount. For example, if the gradation value is 0, ink is not ejected (i.e. the ink ejection amount is zero); if the gradation value is 1, ink of 3 pL is ejected; and if the gradation value is 2, ink of 5 pL is ejected.

Further, for example, as shown in FIG. 6, if the image column (pixel column) of column number #6 is selected as a target of the pixel deleting process, a pixel value (gradation value) of each row in column number #6 is added to a pixel value of this row in one of adjacent image columns of column numbers #5 and #7. At each row, each pixel value in an image column (a pixel column) of column number #6 is added to a smallest pixel value among pixel values in the adjacent image columns of column numbers #5 and #7. In a case shown in FIG. 6, regarding row numbers #3 and #9, pixel values of the image column (pixel column) of column number #6 are added to pixel values of the image column (pixel column) of column number #5; and regarding row number #5, a pixel value of the image column (pixel column) of column number #6 is added to a pixel value of the image column (pixel column) of column number #7. Subsequently, image columns of column numbers #7 to #10 are changed to image columns of column numbers #6 to #9, and thereby the pixel deleting process is finished.

The following part explains a behavior of the image forming apparatus 10.

When the controller 61 receives a print request of duplex printing using the communication device 62, the image generating unit 71 generates raster image data of images to be printed on the first and second surfaces from print data in the print request.

The image processing unit 73 performs a predetermined image process such as halftoning for the images for the first and second surfaces, and further performs the aforementioned correction process.

The print control unit 74 controls the sheet transportation unit 10b and thereby performs transportation of a print sheet to be used for printing, and therewith controls the print engine 10a and performs printing in accordance with the image data after the image process performed for the image for the first surface. In this process, the width W1 of the print sheet is measured by the line sensor 31.

Afterward, the print sheet is transported by the circulation transportation unit 10b2, and the width W2 of the print sheet is measured by the line sensor 31.

Subsequently, the correction processing unit 73a selects an image column range for which the image shrinking process in the image of the second surface on the basis of the width W2 as mentioned, and performs the image shrinking process for the selected image column range.

Subsequently, the print control unit 74 controls the print engine 10a and performs printing in accordance with image data of the image for the second surface after the image shrinking process with a shrinking ratio in the primary scanning direction of the print sheet, and controls the sheet transportation unit 10b and performs transportation and output of the print sheet.

As mentioned, in the aforementioned embodiment, the print engine 10a physically prints an image to be printed on a print sheet in an inkjet manner. The correction processing unit 73a performs a correction process for a specific image column range corresponding to a configuration or a status of the print engine 10a. Further, when performing duplex printing on first and second surfaces of the print sheet, the correction processing unit 73a performs an image shrinking process for an image to be printed on the second surface in accordance with shrinking the print sheet due to ink ejection to the first surface. Further, the correction processing unit 73a selects an image column range other than the specific image column range in the image to be printed on the second surface as a target image column range for which the image shrinking process should be performed.

Consequently, the aforementioned image shrinking process does not affect the aforementioned correction process, and when performing duplex printing, favorable image quality of the second surface is obtained after slightly zooming in accordance with shrinking of a recording medium due to ink ejection to the first surface.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, in a case that the number of one or more pixels to be deleted M is equal to or larger than 2 (i.e. image columns to be deleted is equal to or larger than 2 pixel columns), if there are plural divisional images for which the aforementioned correction process is not performed among the divisional images 111-1 to 111-Nd, the image columns to be deleted are dispersed to the plural divisional images 111-i (i=1, . . . , Nd) in the image shrinking process.

Further, in the aforementioned embodiment, the methods to determine the widths W1 and W2 are not limited to the aforementioned ones.

What is claimed is:

1. An image forming apparatus, comprising:
a print engine configured to physically print an image to be printed on a print sheet in an inkjet manner; and
a correction processing unit configured to perform a correction process for a specific image column range corresponding to a configuration or a status of the print engine;
wherein when performing duplex printing on first and second surfaces of the print sheet, the correction processing unit performs an image shrinking process for an image to be printed on the second surface in accordance with shrinking the print sheet due to ink ejection to the first surface, and the correction processing unit selects an image column range other than the specific image column range in the image to be printed on the second surface as a target image column range for which the image shrinking process should be performed.

2. The image forming apparatus according to claim 1, wherein the correction processing unit (a) derives a number of one or more pixels to be deleted, on the basis of a width of the print sheet in a primary scanning direction after printing of the first surface; (b) divides the print image to be printed on the second surface into divisional images in the primary scanning direction with a division size based on the number of one or more pixels to be deleted and a number of columns in the image column range of the correction process; and (c) selects the target image column range in a divisional image that does not include the specific image column range of the correction process among the divisional images.

3. The image forming apparatus according to claim 1, further comprising a line sensor configured to detect a width of the print sheet in a primary scanning direction after printing of the first surface.

4. The image forming apparatus according to claim 1, wherein the correction process includes at least one of a step correction and a non-ejection nozzle correction,
the step correction is a correction performed for an image column range corresponding to a predetermined range at an end part of a recording head of the print engine, in accordance with a nozzle interval between the recording heads, and
the non-ejection nozzle correction is correction performed for an image column range corresponding to a nozzle not used for ink ejection among nozzles of the recording head of the print engine.
